(19) United States
(12) Patent Application Publication
(10) Pub. No.: US 2005/0270559 A1
(43) Pub. Date: Dec. 8, 2005

(54) Method of sending documents from one PC to another via PHS handsets in a short distance

(75) Inventors: Cheng-Shing Lai, Taipei Hsien (TW); Cui Qi, Nanking (CN)

Correspondence Address: BACON & THOMAS, PLLC, 625 SLATERS LANE, FOURTH FLOOR, ALEXANDRIA, VA, 22314, US

(73) Assignee: Inventec Appliances Corporation, Taipei Hsien (TW)

(21) Appl. No.: 10/859,350

(22) Filed: Jun. 3, 2004

(51) Int. Cl. G06F 15/00

(52) U.S. Cl. 358/1.15

(57) ABSTRACT

The present invention discloses a method of sending documents from one PC to another PC via two PHS handsets in a short distance, which comprises the steps of enabling two PHS handsets to register in a group for establishing a wireless channel for communication, interconnecting a first PHS handset and a first PC by a first interface, interconnecting a second PHS handset and a second PC by a second interface, taking the first PHS handset as a main telephone and the second PHS handset as an extension respectively to establish a connection between the PHS handsets for a subsequent communication in response to calling the second PHS handset by the first PHS handset; and wirelessly sending the document from the first PC to the second PC via the PHS handsets.

### FIELD OF THE INVENTION

The present invention relates to PHS (Personal Handyphone System) and more particularly to a method of sending documents from one PC (personal computer) to another PC or vice versa via two PHS handsets in a short distance.

### BACKGROUND OF THE INVENTION

It is often for a user to send a document from one PC to another. Such sending takes many forms. A simple technique is to send a document over the Internet or network. Alternatively, a document is sent by means of floppy disk, CD_ROM, etc. Moreover, it is possible of sending a document by means of IR (infrared) rays in some types of notebook computer. In addition, novel bluetooth can be used for sending documents.

But software and hardware must be provided for effecting any above techniques. Otherwise, it is difficult of sending documents from one PC to another or vice versa.

Moreover, a wide variety of electronic products are available due to technological advancements. For example, some consumer oriented electronic products including GSM (Global System for Mobile) based cellular phones and PHS handsets are commercially available in the last two decades. Such handsets are advantageous for being lightweight, compact, portable, and inexpensive. Thus, once expensive wireless communications and network services are carried out in an inexpensive way as an indispensable portion of many people in their daily life and work.

PHS has made a significant progress in recent years. Also, PHS handsets are widely promoted by telephone companies. As a result, more and more people like to use PHS handsets. In view of the fact that many people use PHS handsets as their portable communication tools, the present inventor thus spends a lot of time to improve PHS handset with a goal of providing additional features in addition to the simple telephone conversation feature of the existing PHS handset and thus increasing its competitiveness among similar products in the market.

As stated above, many techniques are available for carrying out document sending from one PC to another or vice versa. Thus, it is desirable among users and manufacturers to provide a novel technique of sending documents from one PC to another via two PHS handsets as an additional option for user choice.

### SUMMARY OF THE INVENTION

A primary object of the present invention is to provide a novel method of sending documents from one PC to another PC via two PHS handsets in a short distance. The present invention aims at meeting the needs of the competitive market and is evolved from the description of the background section which states that it is possible of sending a document from one PC to another PC or vice versa over the Internet or by means of floppy disk, CD_ROM, IR rays, or bluetooth. Further, both software and hardware must be provided for effecting any above techniques. By utilizing the present invention, it is possible of providing an additional option for users to choose in sending documents from one PC to another PC or vice versa via two newly available PHS handsets and thus increasing its competitiveness among similar products in the market. Moreover, the above insufficiency of the prior art can be overcome.

One object of the present invention is to command two PHS handsets to register in a group for establishing a connection therebetween such that it is possible of providing a method of sending documents from one PC to another PC or vice versa via the PHS handsets in a short distance. By utilizing the present invention, not only another option of sending documents from one PC to another PC or vice versa is provided but also the above drawback described in the background section can be overcome.

The above and other objects, features and advantages of the present invention will become apparent from the following detailed description taken with the accompanying drawings.

### BRIEF DESCRIPTION OF THE DRAWINGS

FIG. 1 is a block diagram schematically depicting a method of sending a document from one PC to another PC via two PHS handsets according to the invention;

FIG. 2 is a flow chart illustrating a process of establishing a connection between a PC at the sender and a PC at the receiver via two PHS handsets according to the invention;

FIG. 3 is a flow chart illustrating a process of establishing a connection between a PC at the receiver and the PC at the sender according to the invention;

FIG. 4 is a flow chart illustrating a process of sending a document from a PC at the sender to the receiver via two PHS handsets according to the invention, and

FIG. 5 is a flow chart illustrating a process of disconnecting the PC at the sender from the PC at the receiver via two PHS handsets according to the invention.

### DETAILED DESCRIPTION OF THE PREFERRED EMBODIMENTS

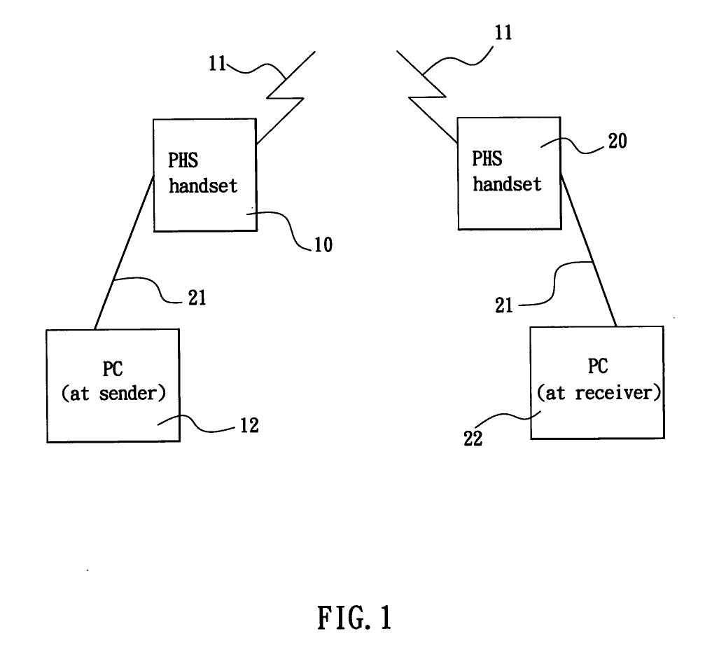

Referring to FIG. 1, there is shown a method of sending a document from one PC to another PC via two PHS handsets in a short distance in accordance with the invention. The method commands two PHS handsets 10 and 20 to register in a group for establishing a connection therebetween. A wireless channel 11 is provided for communication between the PHS handsets 10 and 20. A first interface 21 is interconnected the PHS handset 10 and a PC 12 at sender and a second interface 21 is interconnected the PHS handset 20 and a PC 22 at receiver. Next, one of the PHS handsets 10 and 20 (e.g., the PHS handset 10) is taken as a main telephone and the other one (e.g., the PHS handset 20) is taken as an extension so as to form a group. A connection (i.e., communication) between the PHS handsets 10 and 20 can be established when one PHS handset 10 calls the other PHS handset 20. Thus, it is possible of wirelessly sending a document from one PC 12 at the sender to another PC 22 at the receiver via the PHS handsets 10 and 20 in a short distance (e.g., within 100 meters).

In the invention technology involved the communication between two PHS handsets is that two PHS handsets 10 and 20 can communicate over a specific channel without passing a CS (cell station). The functional channels employed in the communication between the PHS handsets comprise a SCCH (signalling control channel), a TCH (traffic channel), and a FACCH (fast associated control channel). In the invention a document is sent over the FACCH.

Moreover, in the invention as stated above, the PHS handset 10 is taken as a main telephone and the PHS handset 20 is taken as an extension so as to form a group. Thus, a free communication between the main telephone and the extension can be established.

Additionally, in the invention the interface 21 between the PHS handset 10 and the PC 12 or between the PHS handset 20 and the PC 22 is either RS232 or USB (Universal Serial Bus). How to command a PHS handset to register in a group is well known and is not pertinent to the invention. Thus a detailed description thereof is omitted herein for the sake of brevity.

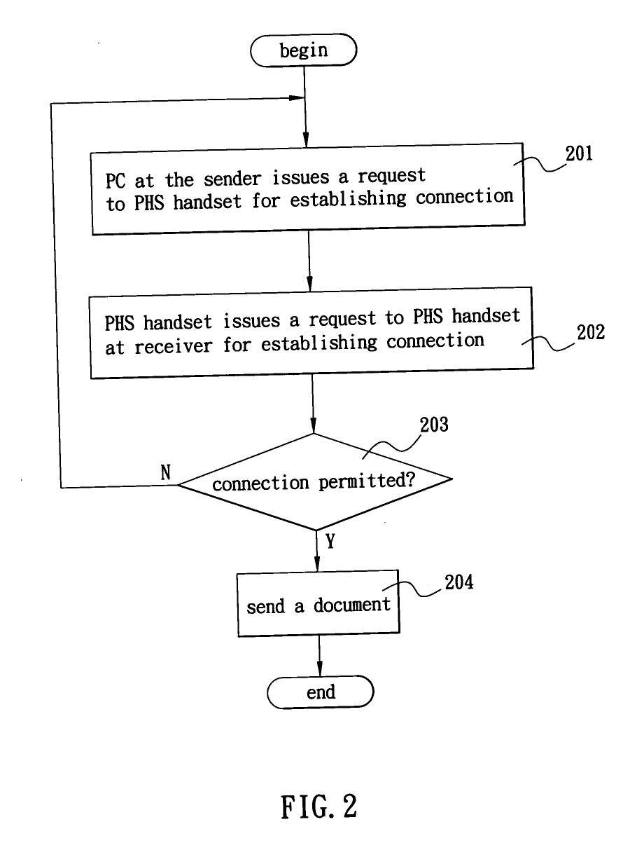

Referring to FIG. 2 in conjunction with FIG. 1, there is shown a flow chart illustrating a process of establishing connection between the PC 12 at the sender and the PC 22 at the receiver via the PHS handsets 10 and 20 according to the invention.

In step 201, the PC 12 at the sender issues a request to the PHS handset 10 for establishing a connection therebetween and waits for confirmation.

In step 202, the PHS handset 10 issues a request to the PHS handset 20 at the receiver for establishing a connection therebetween and waits for reply.

In step 203, it is determined whether an acknowledgement (i.e., connection permission) has been received from the receiver. If yes, the process goes to step 204. Otherwise, the process loops back to step 201.

In step 204, a connection between the sender and the receiver is established and then the PC at the sender begins to send a document to the receiver. The process ends immediately.

Note that a time-out control can be provided in step 203 for determining whether an acknowledgement has been received from the receiver (i.e., during waiting). A user has the option of keeping on waiting or disconnecting prior to sending a request again if time set in the time-out control has expired.

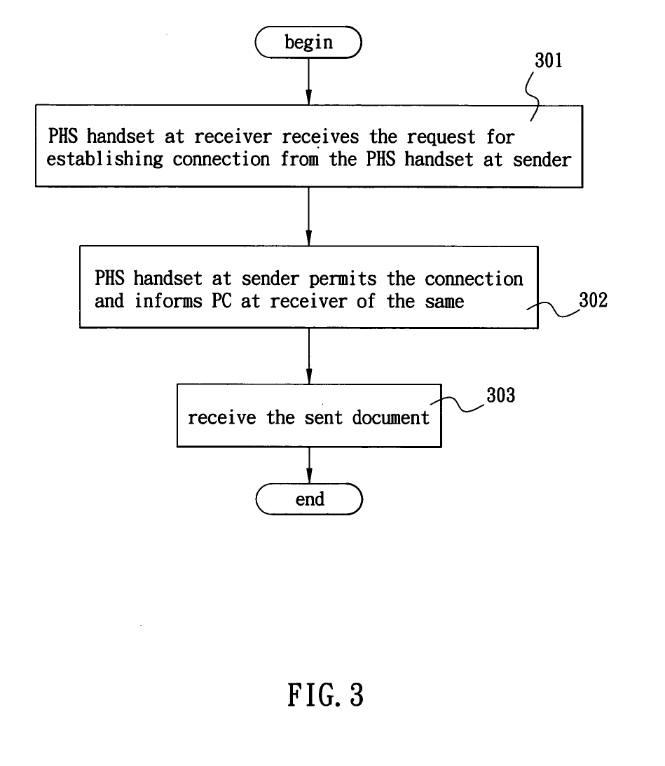

Referring to FIG. 3 in conjunction with FIG. 1, there is shown a flow chart illustrating a process of establishing a connection between the PC 22 at the receiver and the PC 12 at the sender according to the invention.

In step 301, the PHS handset 20 at the receiver receives the request for establishing a connection from the PHS handset 10 at the sender.

In step 302, the PHS handset 10 at the sender permits the connection and informs the PC 22 at the receiver of the same.

In step 303, the PC at the receiver 22 begins to receive the sent document. The process ends immediately.

Note that an automatic reply mode can be provided in step 302 when the PHS handset 10 at the sender informs the PC 22 at the receiver of the connection permission. Alternatively, a manual reply mode can be provided for waiting the reply from the PC 22 at the receiver. In the manual reply mode, a connection rejection can be provided.

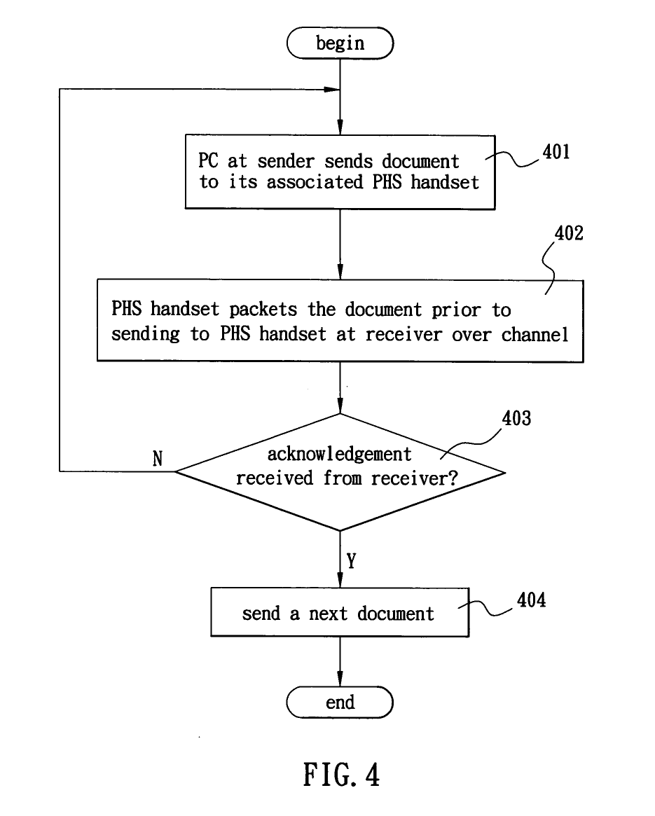

Referring to FIG. 4, there is shown a flow chart illustrating a process of sending a document from the PC 12 at the sender to the receiver via the PHS handsets 10 and 20 according to the invention. This process aims at increasing reliability of document sending by incorporating a document resending mechanism therein.

In step 401, the PC 12 at the sender sends a document to the associated PHS handset 10.

In step 402, the PHS handset 10 packets the document received from the PC 12 at the sender. Next, the packets of the document are sent from the PHS handset 10 to the PHS handset 20 at the receiver over the channel 11. The document can be packetd based on PHS radio frequency transmission management and is sent over FACCH.

In step 403, it is determined whether an acknowledgement from the receiver has been received. If yes, the process goes to step 404. Otherwise, the process loops back to step 401 to send the document again.

In step 404, send a next document. The process ends immediately.

Note that a time-out control can be provided in step 403 for determining whether an acknowledgement has been received from the receiver (i.e., during waiting). A user can send the document again if time set in the time-out control has expired.

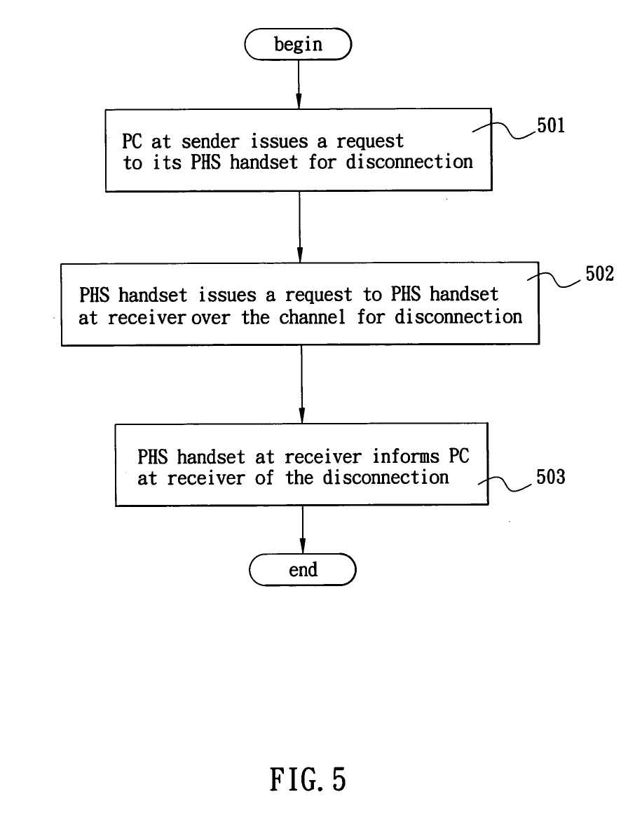

Referring to FIG. 5 in conjunction with FIG. 1, there is shown a flow chart illustrating a process of disconnecting the connection between the PC 12 at the sender and the PC 22 at the receiver via the PHS handsets 10 and 20 according to the invention.

In step 501, the PC 12 at the sender issues a request to the PHS handset 10 for disconnecting the connection.

In step 502, the PHS handset 10 issues a request to the PHS handset 20 at the receiver over the channel 11 for disconnecting the connection.

In step 503. The PHS handset 20 at the receiver informs the PC 22 at receiver of the disconnection. The process ends immediately.

While the invention has been described by means of specific embodiments, numerous modifications and variations could be made thereto by those skilled in the art without departing from the scope and spirit of the invention set forth in the claims.

1. A method of sending a document from a first PC to a second PC via PHS handsets in a short distance, the method comprising the steps of:
enabling the first and second PHS handsets to register in a group for establishing a wireless channel for communication between the PHS handsets;
interconnecting the first PHS handset and the first PC by a first interface;
interconnecting the second PHS handset and the second PC by a second interface;
taking the first PHS handset as a main telephone and the second PHS handset as an extension respectively;
establishing a connection between the PHS handsets for a subsequent communication in response to calling the second PHS handset by the first PHS handset; and
wirelessly sending the document from the first PC to the second PC via the PHS handsets.

2. The method of claim 1, wherein the communication between the PHS handsets is done by the PHS handsets communicating over predetermined channel means without passing a CS.

3. The method of claim 1, wherein each of the first and the second interfaces is either RS232 or USB.

4. The method of claim 1, wherein the first PC is located at a sender, the second PC is located at a receiver, and for establishing a connection to the first PHS handset at the sender the first PC at the sender performs operations comprising:
enabling the first PC at the sender to issue a request to the first PHS handset at the sender for establishing a connection therebetween and waiting for confirmation;
enabling the first PHS handset at the sender to issue a request to the second PHS handset at the receiver for establishing a connection therebetween and waiting for reply; and
establishing a connection between the sender and the receiver and enabling the first PC at the sender to send the document to the receiver in response to receiving a connection permission from the receiver.

5. The method of claim 4, further comprising the step of providing a time-out control while waiting for reply from the receiver.

6. The method of claim 4, wherein for establishing a connection to the first PC at the sender the second PC at the receiver performs operations comprising:
enabling the second PHS handset at the receiver to receive the request from the first PHS handset at the sender for establishing a connection;
enabling the first PHS handset at the sender to permit the connection and inform the second PC at the receiver of the same; and
enabling the second PC at the receiver to receive the sent document.

7. The method of claim 6, further comprising the step of providing an automatic reply mode when the first PHS handset at the sender informs the second PC at the receiver of the connection permission, or a manual reply mode for waiting an instruction from the second PC at the receiver.

8. The method of claim 4, wherein for increasing reliability of the document sending further comprises the steps of:
enabling the first PC at the sender to send the document to the first PHS handset at the sender;
enabling the first PHS handset at the sender to packet the document received from the first PC at the sender;
sending the packets of the document to the second PHS handset at the receiver over the channel; and
sending a next document in response to receiving an acknowledgement from the receiver.

9. The method of claim 8, further comprising the step of providing a time-out control while waiting for the acknowledgement from the receiver.

10. The method of claim 4, wherein for disconnecting the connection to the first PC at the sender the second PC at the receiver performs operations comprising:
enabling the first PC at the sender to issue a request to the first PHS handset at the sender for disconnection;
enabling the first PHS handset at the sender to issue a request to the second PHS handset at the receiver over the channel for disconnection; and
enabling the second PHS handset at the receiver to inform the second PC at receiver of the disconnection.
